(19) United States
(12) Patent Application Publication
(10) Pub. No.: US 2023/0213054 A1
(43) Pub. Date: Jul. 6, 2023

(54) GRADIENT INSULATION SCREW WITH RIGHT-HANDED ROTATION DRILLING TIP AND LEFT-RIGHT THREAD FOR ADJUSTABLE FASTENING OF A ROOFING MEMBRANE ON A STEEL SHEET

(71) Applicant: EJOT SE & Co. KG, Bad Berleburg (DE)

(72) Inventors: Ewald LAMMER-KLUPAZEK, Baierdorf bei Anger (AT); Volker Wagner, Gießen (DE); Michael HELLWIG, Bad Laasphe (DE); Kostja HEINRICH, Bad Berleburg (DE); Uwe SIEGEMUND, Bad Berleburg (DE)

(21) Appl. No.: 17/928,057

(22) PCT Filed: Mar. 26, 2021
(86) PCT No.: PCT/EP2021/057881

§ 371 Date: Nov. 28, 2022

(30) Foreign Application Priority Data
Jun. 5, 2020 (DE) 10 2020 207 059.8

(51) Int. Cl. F16B 25/00; F16B 25/10; E04D 11/02

(52) U.S. Cl. CPC F16B 25/0063; F16B 25/103; F16B 25/0021; E04D 11/02

(57) ABSTRACT

A gradient insulation screw (1) for adjustable fastening of a roofing membrane (2) on a substrate, in particular a steel sheet (3), the gradient insulation screw (1) comprising a drilling tip (4) with a first direction of rotation; following the drilling tip (4), an assembly thread (7) with a second direction of rotation, which differs from the first direction of rotation; following the assembly thread (7), a first thread-free region (8); following the first thread-free region (8), an adjustment thread (9) with the first direction of rotation, the outer diameter of which is greater than the outer diameter of the assembly thread (7) and the drilling tip (4); and following the adjustment thread (9), a tool holder (10) as well as a system (11) for adjustable fastening of a roofing membrane (2) on a substrate with a gradient insulation screw (1) and a holding element (12) and a method for adjustable fastening of a roofing membrane (2) on a substrate using such a system (11).

The present invention relates in general to a gradient insulation screw, a system of gradient insulation screw and holding element, as well as a method for adjustable fastening of a roofing membrane on a substrate, in particular a steel sheet.

In the case of flat roofs, the insulating material is optionally fastened to the substrate together with a roofing membrane arranged there above with the aid of screws and holding elements. The substrate can be, inter alia, a steel sheet, for example in the form of a steel trapezoidal sheet. Therefore, the fastening is described in the following predominantly with reference to a steel sheet substrate. The person skilled in the art knows, however, that the fastening can also be achieved in the same way for the case of other substrates.

With the aid of insulating materials of different thicknesses, a gradient can be formed on the outer side of the flat roof. The roof gradient is adapted, for example, such that rainwater can flow off in a desired direction on the roof. A typical value of such a roof gradient amounts to approximately 3%.

In the prior art, various screws and holding elements for fastening insulating materials on a flat roof are known. Due to the insulating materials of different thicknesses, screws and holding elements having however a plurality of different lengths must be used for the assembly. Since there is not a suitable screw with holding element for each possible insulating material thickness, the screws are screwed into the substrate to different depths. In the case of a substrate made of steel sheet, this has the disadvantage that the screws protruding to different extents can be seen from the underside of the roof, which may be perceived as an optical deficiency.

Therefore, the object exists to improve the assembly of insulating material in particular with gradient on a flat roof.

This object is solved by the gradient insulation screw, the system of gradient insulation screw and holding element, and the method for adjustable fastening of the independent claims. Advantageous embodiments are explained in the dependent claims.

In connection with the present invention, a gradient insulation screw is a screw, as it is defined by the further claim features. Such a screw is particularly well suited according to the invention to fasten, optionally with a corresponding holding element, a first element, such as, for example, an insulating material, to a second element, such as, for example, a substrate. Thereby, according to the invention, the fastening is particularly flexible, so that, for example, insulating material having different thicknesses, such as can be used, for example, to achieve a gradient, can be fastened with the aid of the screw.

A gradient insulation screw according to the invention for adjustable fastening of a roofing membrane on a substrate comprises: a drilling tip with a first direction of rotation, following the drilling tip an assembly thread with a second direction of rotation, which differs from the first direction of rotation, following the assembly thread a first thread-free region, following the first thread-free region an adjustment thread with the first direction of rotation, wherein the outer diameter of the adjustment thread is greater than the outer diameters of the assembly thread and the drilling tip, and following the adjustment thread a tool holder.

The present invention has the technical advantage that particularly insulations for achieving a gradient can be fastened, in particular on steel sheets, using the screw according to the invention with only one length or with at least a substantially smaller number of different lengths. Because with the aid of the adjustment thread, the length of the fastening system consisting of the screw and a holding element can be adjusted to different lengths.

In addition, the screws according to the invention have the advantage that, in the final assembly state, they protrude to the same extent from the underside of the steel sheet. Because, when the screw according to the invention is used as intended, in the final assembly state—independently of the thickness of the insulating material to be fastened—the assembly thread is located below the steel sheet, the first thread-free region is located in the opening in the steel sheet, and the adjustment thread is located above the steel sheet (i.e., the side with the insulating material).

In addition, the combination according to the invention of the threads and the drilling tip with different directions of rotation prevents the screw from moving within the opening in the steel sheet, i.e., from looking more or less out on the underside, when adjusting the length of the fastening system consisting of screw and holding element. Because, by rotating the screw in the second direction, the holding element moves in the direction of the steel sheet and can thus be shortened, but the adjustment thread cannot run into the opening in the steel sheet and thus influence the fastening of the screw in the steel sheet.

The gradient insulation screw according to the invention consists of regions, such as the drilling tip, various threads and thread-free regions, which extend starting from the front end to the rear end. The front end of the screw is that end of the screw, which is first moved into the substrate during the assembly, and the rear end of the screw is the opposite end, which is closest to the surface of the roofing membrane at the end of the assembly. The order of the individual regions is determined in that one region follows another region. However, it is clear to the person skilled in the art that these regions do not necessarily have to follow one another directly. The person skilled in the art also knows additional regions, which can be arranged between the regions following one another. Examples of this are the further threads and thread-free regions, which are described in the following.

In general, a screw consists of a core and a thread arranged on the core, wherein the radial expansion of the screw can be described with the aid of two diameters. Thereby, the core diameter is the diameter of the core of the screw and the outer diameter is the diameter of the screw, taking into account the thread arranged on the core. The thread has a pitch, wherein the pitch denotes the path that is covered during a full rotation. A thread-free region of a screw consists only of the core and comprises no thread. Accordingly, in this region, the core diameter corresponds to the outer diameter. In addition, screws can comprise threads with different directions of rotation. Thereby, in general, right-handed threads and left-handed threads are distinguished. A drilling tip is a tip of a screw, which is designed to drill a hole into a substrate. Therefore, a drilling tip is similar to the design of a driller. The drilling tip generally comprises a body with one or more recesses and/or one or more projections. The diameter of the body can change, in particular become greater, over the longitudinal extension of the drilling tip from the tip of the drilling tip in the direction of the assembly thread following thereon. The diameter of the body at its thickest location, for example at the transition to the assembly thread, can be referred to as core diameter and the largest diameter of the drilling tip, taking into account any projections, as outer diameter. In connection with invention, the body of the drilling tip may comprise different shapes. The body may, for example, be designed to be conical overall or a frustoconical or cylindrical body may follow the tip of the drilling tip. The optionally present projections may be cutting edges and/or a thread arranged on the drilling tip.

The gradient insulation screw according to the invention comprises at least two threads and a drilling tip. The drilling tip and the threads have alternating directions of rotation, seen from the drilling tip of the gradient insulation screw. According to a preferred embodiment, the screw may comprise a right-handed drilling tip, a left-handed assembly thread and again a right-handed adjustment thread. According to an alternative embodiment, a left-handed drilling tip, a right-handed assembly thread and again a left-handed adjustment thread are used. The assembly thread and the adjustment thread can have the same pitch, i.e., when the gradient insulation screw is rotated, it can undergo the same axial advance, independently of whether the advance of the screw is carried out by the assembly thread or by the adjustment thread.

Below, the invention is described by way of example with reference to the embodiment with a right-handed drilling tip, a left-handed assembly thread and again a right-handed adjustment thread. However, this does not mean that the invention is limited to this embodiment.

After the drilling tip has been screwed in in a first direction of rotation, the assembly thread is screwed in the substrate, for example the steel sheet, by a change to a second direction of rotation. At the end of the assembly thread, the first thread-free region follows. When the assembly thread is moved through the steel sheet during the assembly by rotating the gradient insulation screw in the second direction of rotation, the steel sheet is afterwards located in this first thread-free region. Since no thread is located in this region, the gradient insulation screw can then be further rotated without it moving further into the steel sheet.

The adjustment thread is designed to adjust, together with a holding element of a fastening system, the length of the fastening system consisting of screw and holding element. According to the invention, the outer diameter of the adjustment thread is greater than the outer diameter of the drilling tip and the outer diameter of the assembly thread so that the screw according to the invention can be connected to a holding element in a simple manner. Thus, first the drilling tip and then the assembly thread of the screw can be guided, during connection to the holding element, through a hollow shaft of the holding element until the adjustment thread engages in the hollow shaft.

In a preferred embodiment of the gradient insulation screw according to the invention, a second thread-free region is arranged between the drilling tip and the assembly thread. The second thread-free region has a length on which the gradient insulation screw must be pushed through the steel sheet until the assembly thread is started to be screwed into the steel sheet. This has the technical advantage that, as a result of a longer axial movement of the gradient insulation screw, it is indicated to the assembling person that the hole has been drilled in the substrate. As a result, the assembling person better recognizes the point in time at which the direction of rotation must be changed, since the drilling process takes place deep in the interior of the insulating material and is thus invisible for the assembling person.

The arrangement of a region, such as the just described second thread-free region, between two other regions of the gradient insulation screw according to the invention merely defines the order of the individual regions of the gradient insulation screw. The arrangement of the region between two other regions does not necessarily mean that these regions have to follow one another directly. In connection with the present invention, further regions can be arranged between these regions.

In a further preferred embodiment of the gradient insulation screw according to the invention, a preassembly thread with the first direction of rotation is arranged between the drilling tip and the assembly thread. The preassembly thread can have the same pitch as the adjustment thread. This preassembly thread supports the arrangement of the gradient insulation screw in the substrate as intended. As soon as the preassembly thread engages in the substrate, the movement of the gradient insulation screw relative to the substrate depends on the rotation of the screw and not on the pressure exerted by the assembling person. The preassembly thread can follow the drilling tip directly. In connection with the present invention, however, other regions can also be arranged between the drilling tip and the preassembly thread, such as, for example, the above-described second thread-free region.

According to a further preferred embodiment of the gradient insulation screw according to the invention, a third thread-free region is arranged between the preassembly thread and the assembly thread. This third thread-free region enables a simple change of the direction of rotation from the preassembly thread with the first direction of rotation to the assembly thread with the second direction of rotation.

In a further preferred embodiment of the gradient insulation screw according to the invention, the preassembly thread and the assembly thread comprise substantially the same outer diameter and/or core diameter. Alternatively, the preassembly thread may comprise a smaller outer diameter and/or core diameter as compared to the assembly thread. Both have the technical advantage that the assembly thread can further use the opening formed in the steel sheet by the drilling tip and/or the preassembly thread. As a result, the expenditure of force when using the assembly thread is reduced.

In a further preferred embodiment of the gradient insulation screw according to the invention, the drilling tip comprises at least one cutting element. This has the technical advantage that the gradient insulation screw can be placed in a simple manner without pre-drilling in the roofing membrane or in the steel sheet. The cutting element enables a positionally accurate initial placing of the gradient insulation screw.

In connection with the present invention, the drilling tip comprises a first direction of rotation. The drilling tip is therefore adapted to drill into a substrate when it is rotated in the first direction of rotation. In principle, such a drilling tip is similar to the design of a driller. The drilling tip generally comprises a body with a tip and one or more recesses and/or one or more projections. As described above, the body of the drilling tip may comprise different shapes. A frustoconical or cylindrical body may, for example, follow the tip of the drilling tip. The body may, however, also be adapted to be conical overall.

In a preferred embodiment of the gradient insulation screw according to the invention, the drilling tip comprises a tip at the front end, i.e., at the end that first appears on the substrate during the assembly. This tip preferably comprises at least one main cutting edge, which is aligned at an angle to the axis of rotation of the gradient insulation screw. The at least one main cutting edge forms the first opening in the substrate in most applications. The at least one main cutting edge preferably extends from the axis of rotation of the gradient insulation screw at an angle radially outwards.

In a further preferred embodiment of the gradient insulation screw according to the invention, the drilling tip comprises at least one secondary cutting edge. The at least one secondary cutting edge is arranged on the lateral surface of the body of the drilling tip. The secondary cutting edge enlarges the drilling hole and removes any drill residues. The at least one secondary cutting edge is preferably arranged on the outer side of the lateral surface in such a way that it protrudes as a projection at least partially in relation to the body.

Along the at least one main cutting edge and/or the at least one secondary cutting edge, a chip groove extends in a further preferred embodiment. The chip groove extends substantially in the direction of the axis of rotation of the gradient insulation screw and it is adapted to assist in the removal of the drilling chips.

The cutting edges of the drilling tip are designed to drill a drilling hole into the substrate when the drilling tip is rotated in the first direction of rotation. In particular, the at least one secondary cutting edge and the at least one chip groove can then be adapted in such a way that when the drilling tip is rotated in the first direction of rotation, the secondary cutting edge first cuts at the substrate and then the chip groove follows. Further preferred, the at least one secondary cutting edge and the chip groove are arranged in a spiral shape, wherein the spiral is preferably arranged like a thread with which the drilling tip can be screwed into the substrate.

In yet a further preferred embodiment of the gradient insulation screw according to the invention, the third thread-free region comprises a length in the longitudinal direction of the gradient insulation screw which is greater than the thickness of the steel sheet. This simplifies the changing of the direction of rotation of the gradient insulation screw during the assembly from the first direction of rotation to the second direction of rotation.

In a further preferred embodiment of the gradient insulation screw according to the invention, the first thread-free region comprises a diameter which is smaller than or equal to the greater of the outer diameter of the drilling tip and the core diameter of the assembly thread. When the screw also comprises a preassembly thread, the diameter of the first thread-free region is smaller than or equal to the greatest of the outer diameter of the drilling tip and the core diameters of the preassembly thread and the assembly thread. In most cases, the diameter of the drilling into the substrate is dependent on the outer diameter of the drilling tip and the core diameter of the assembly thread and, if applicable, of the preassembly thread. The use of a first thread-free region, the diameter of which is smaller than or equal to this outer diameter and these core diameters, ensures that the screw can be freely rotated when the first thread-free region is located in the steel sheet.

In yet a further preferred embodiment of the gradient insulation screw according to the invention, the first thread-free region comprises a length in the longitudinal direction of the gradient insulation screw which is greater than the thickness of the steel sheet. As a result, the screw according to the invention can move relatively freely in the opening in the steel sheet during the adjustment of the length of the fastening system, without the integrity of the fastening being impaired. This is helpful, for example, when pressure is exerted on the fastening system from above, for example when walking on the roof. Then, the screw can move downwards at times in the opening in the steel sheet and can move upwards again.

In yet a further preferred embodiment of the gradient insulation screw according to the invention, a thickening follows the first thread-free region. This thickening can also be referred to as a collar. The diameter of the collar or of the thickening is greater than the diameter of the first thread-free region. A thickening or a collar following the first thread-free region has the technical effect that it can be prevented with simple means that the adjustment thread engages in the steel sheet. In principle, the thickening can also be adapted as a rotationally symmetrical ramp, via which the diameter of the gradient insulation screw, in the direction of the adjustment thread, increases to the core diameter of the adjustment thread, starting with the diameter of the first thread-free region. In this case, the ramp serves a continuous thickness design of the gradient insulation screw.

The above object is also solved by a system of the gradient insulation screw according to the invention and a holding element. Hereby, the holding element comprises a holding plate and a hollow shaft, which follows the holding plate and which is adapted such that the adjustment thread of the gradient insulation screw can engage in the hollow shaft. As a result, a simple, but also particularly effective fastening of a roofing membrane on a steel sheet is provided. Because with the aid of the adjustment thread, the position of the holding element on the gradient insulation screw and thus the length of the system can be varied. As a result, the system can be used for a plurality of different thicknesses of insulating material.

In a preferred embodiment of the system according to the invention of gradient insulation screw and holding element, the hollow shaft of the holding element comprises projections, which are adapted complementary to the adjustment thread of the gradient insulation screw. Hereby, this can be a complementary internal thread. The person skilled in the art also knows, however, that an interplay with a thread can also be achieved by individual projections, which are not adapted as threads.

In an alternative embodiment, the complementary thread in the hollow shaft is formed for the first time when the gradient insulation screw is screwed into the hollow shaft. Preferably, the inner diameter of the hollow shaft of the holding element is smaller than the outer diameter of the adjustment thread, but greater than the core diameter of the adjustment thread. This enables that the adjustment thread taps and/or cuts into the material of the hollow shaft of the holding element and thereby a mother thread forms during the screwing in for transmission of force between gradient insulation screw and holding element in the hollow shaft. Via the transmission of force, suction forces by wind, which act on the roof membrane, can be efficiently dissipated.

In a further preferred embodiment of the system according to the invention of gradient insulation screw and holding element, the inner diameter of the hollow shaft of the holding element is greater than the outer diameters of the drilling tip, the preassembly thread (if present) and the assembly thread of the gradient insulation screw. This enables a simple connection of the holding element to the adjustment thread of the gradient insulation screw. Thus, the gradient insulation screw can be guided, during connection to the holding element, with the tip leading into the hollow shaft of the holding element until the adjustment thread engages in the hollow shaft.

In yet a further preferred embodiment of the system according to the invention of gradient insulation screw and holding element, the gradient insulation screw is made of a material which is harder than the material of the holding element.

In yet a further preferred embodiment of the system according to the invention of gradient insulation screw and holding element, the gradient insulation screw is made of metal and the holding element is made of plastic.

The above object is also solved by a method for the adjustable fastening of a roofing membrane on a steel sheet by means of the system according to the invention of gradient insulation screw and holding element, wherein the method comprises the following steps: pushing the drilling tip of the gradient insulation screw of the system into the roofing membrane in the direction of the steel sheet located underneath, screwing the drilling tip of the gradient insulation screw into the steel sheet in the first direction of rotation, screwing the assembly thread of the gradient insulation screw into the steel sheet in a second direction of rotation, which differs from the first direction, until the first thread-free region of the gradient insulation screw is located in the steel sheet, and further rotating the gradient insulation screw in the second direction of rotation, until the holding plate of the holding element of the system rests on the roofing membrane. The method according to the invention enables a simple and reliable fastening of the roofing membrane on the steel sheet.

In particular, at the end of the assembly method according to the invention, the holding plate can rest on the roofing membrane in such a way that a surface-flush termination with the roofing membrane occurs. I.e., it is possible that the surface of the holding plate lies in a plane with the roofing membrane, so that no irregularities arise on the assembled roofing membrane due to the assembled holding plates.

If the pushing of the drilling tip of the gradient insulation screw of the system made of gradient insulation screw and holding element into the roofing membrane in the direction of the steel sheet located underneath leads to a resting of the holding plate on the roofing membrane, but does not lead to a contact of the drilling tip with the steel sheet, the method according to the invention may further comprise: screwing the adjustment thread of the gradient insulation screw in the first direction of rotation into the holding element until the drilling tip comes into contact with the steel sheet.

If the gradient insulation screw has a preassembly thread, the method according to the invention may further comprise: screwing the preassembly thread of the gradient insulation screw in the first direction of rotation into the steel sheet until the second thread-free region of the gradient insulation screw is located in the steel sheet. As a result, it is achieved that the adjustment thread is screwed a minimum distance in depth into the holding element. The minimum distance amounts to the length of the preassembly thread. As a result, the risk of a detachment of the holding plate from the screw during the assembly is minimized. In addition, pressure exerted by the assembling person from above on the system consisting of gradient insulation screw and holding plate is dissipated by the preassembly thread onto the steel sheet. Thus, any impact of the assembly thread on the drilling hole in the steel sheet is avoided. As a result, it is avoided that neither the drilling hole nor the assembly thread are damaged by impact, which would result in a less reliable assembly of the roofing membrane.

As already explained above, the invention is described with reference to an exemplary embodiment with a right-handed drilling tip, a left-handed thread and again a right-handed thread. However, this does not mean that the invention is limited to this embodiment. The alternative embodiment with a left-handed drilling tip, a right-handed thread and again a left-handed thread can be used in the same way.

In a preferred embodiment, first an insulating material and then a roofing membrane is applied on a steel sheet. The roofing membrane can contain markings at regular, possibly grid-shaped positions, at which systems according to the invention of gradient insulation screw and holding element are to be introduced. It is possible, but not necessary, that pre-drillings are already located in the roofing membrane at the regular positions.

Preferably, the two parts of the system, the gradient insulation screw and the holding element, are connected to one another before pushing in the drilling tip of the system. This connection can take place, for example, at the construction site or directly after the production of the two parts. On the construction site, a gradient insulation screw with holding element is then pushed into the roofing membrane, for example, at one of the regular positions. The pushing in can be supported by a right-hand turning of the gradient insulation screw. In principle, however, the gradient insulation screw can also be pushed directly into the roofing membrane without rotation. The drilling tip of the gradient insulation screw is guided down through the insulating material onto the steel sheet. By pressure from above on the tool holder or by rotating the tool holder, respectively, the drilling tip of the gradient insulation screw is also pushed through the steel sheet. By right-hand rotation, the preassembly thread is now optionally screwed into the steel sheet. The holding element is thereby held by the insulating material such that it does not also rotate.

As soon as the steel sheet has migrated over the drilling tip and optionally over the preassembly thread of the screw, the screw does not move further into the substrate. Instead, due to continued right-handed rotation relative to the holding element, the holding plate can lift off from the roofing membrane noticeably for the assembling person. This gives the assembling person an indication that the direction of rotation must now be changed, in the present example into the left-handed run. In connection with the method according to the invention, the assembly thread is then screwed in by left-handed rotation until the steel sheet is located in the first thread-free region of the screw. In addition, the left-handed rotation has the effect of that the holding element moves with the holding plate again in the direction of the substrate.

For the system according to the invention, the adjustment thread of the gradient insulation screw is arranged during the assembly at least partially in the hollow shaft of the holding element. The adjustment thread engages into the hollow shaft, for example into an internal thread located there, which is formed for example by the screwing in of the adjustment thread into the hollow shaft. However, as already explained above, the adjustment thread can also engage in the hollow shaft differently.

As long as the holding element does not touch the roofing membrane and/or the insulation, the holding element rotates with the screw. However, when the holding element contacts the roofing membrane and/or the insulation, the screw rotates relatively to the holding element. Depending on the rotational movement of the screw, the holding element then moves in the direction of the steel sheet or away from the steel sheet.

In a preferred embodiment, the holding element is adapted such that it is held in the roofing membrane and/or the insulating material in a force-fitting and/or form-fitting manner. Thus, the holding element can, for example, comprise projections on the surface contacting the insulating material, which prevent co-rotation of the holding element during rotation of the screw.

In connection with the present invention, the screw is rotated further in the left-handed direction when the steel sheet is located in the first thread-free region. Due to the first thread-free region, the gradient insulation screw then does not penetrate further into the steel sheet. In addition, due to the continued left-handed rotation, the assembly thread is prevented from threading into the steel sheet again and thus the screw being rotated out of the steel sheet again. However, the screw rotates relatively to the holding element, for example, due to the above-described contact of the holding element with the roofing membrane and/or with the insulation. Due to the interplay of the hollow shaft of the holding element and the right-handed thread of the adjustment thread, the holding element moves in the direction of the steel sheet.

The invention is now explained in more detail with reference to the attached drawings. This results in further details and features of the subject-matter of the invention. In the drawings:

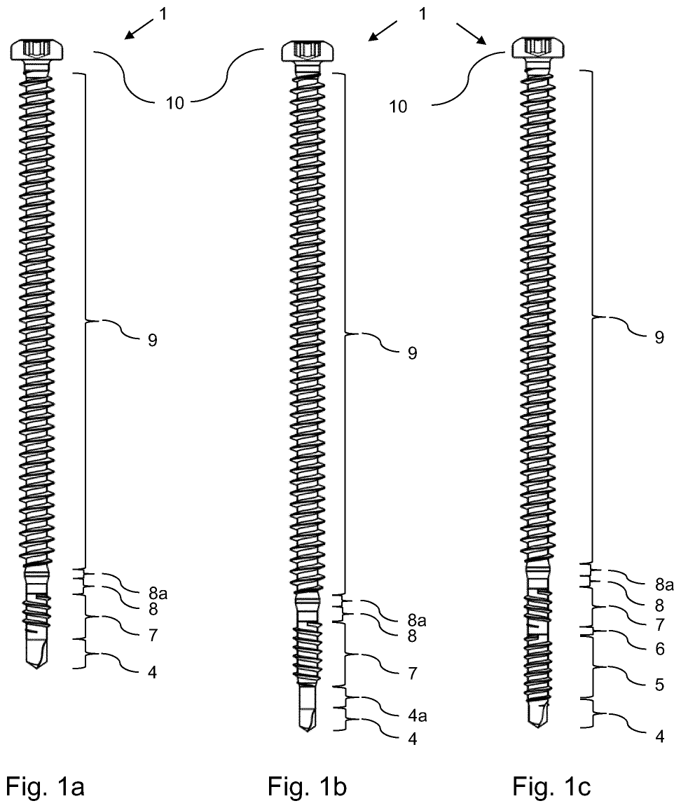

FIGS. 1a to 1c are examples of a gradient insulation screw according to the invention with and without preassembly thread and thread-free region;

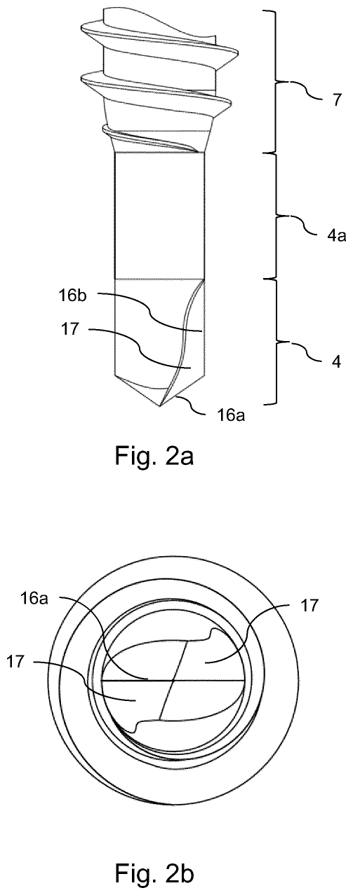

FIGS. 2a and 2b are a schematic side view or a schematic top view of a drilling tip of a gradient insulation screw according to the invention;

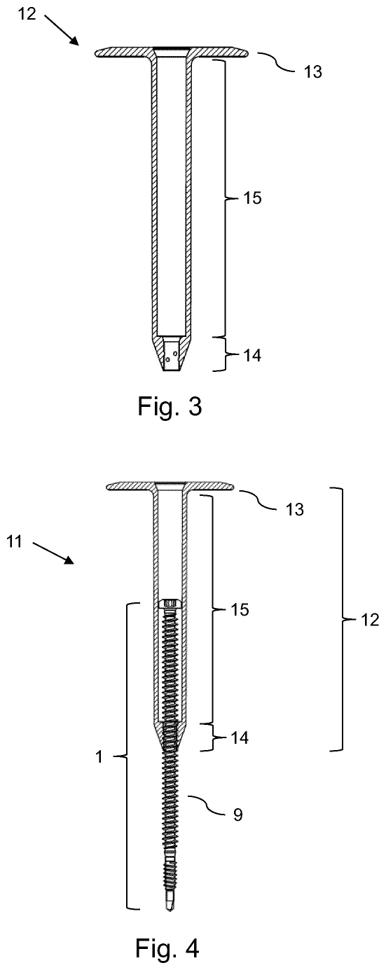

FIG. 3 is a vertical section through a holding element, which can be used together with the gradient insulation screws shown in FIG. 1 in a system according to the invention;

FIG. 4 is an example of a system according to the invention made of the holding element from FIG. 3 and the gradient insulation screw from FIG. 1B;

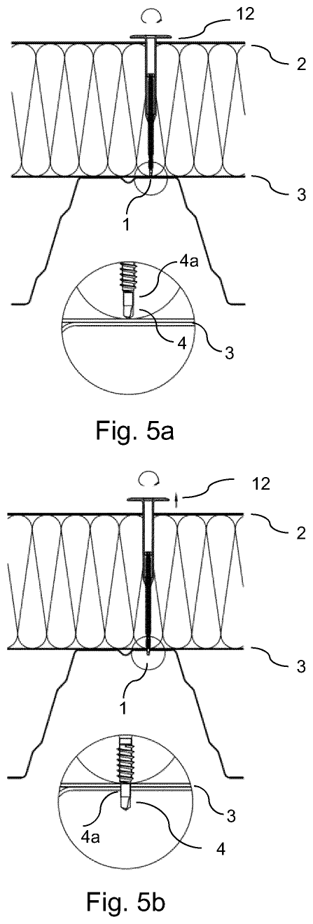

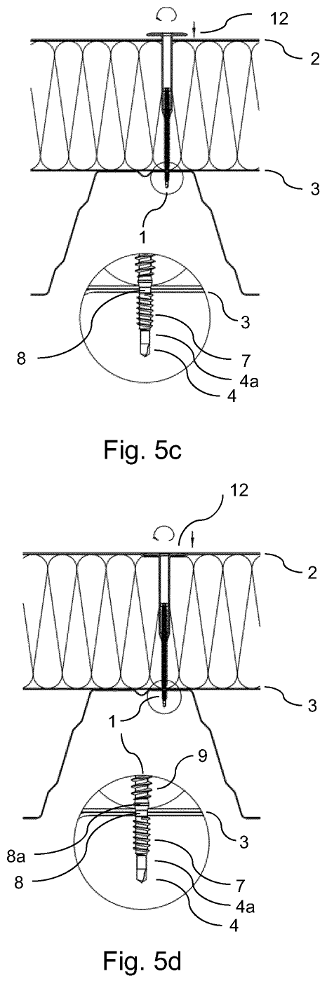

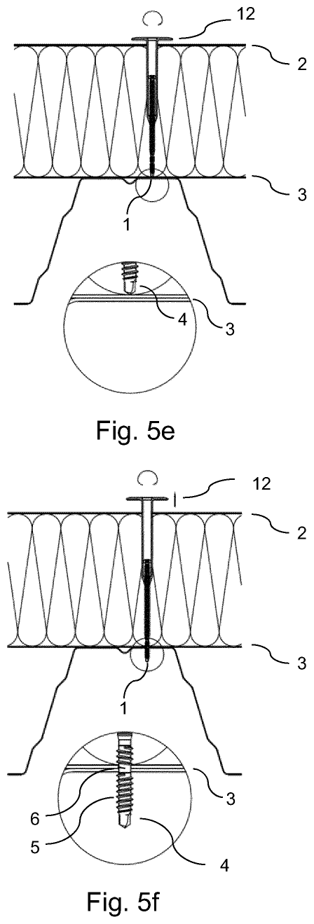

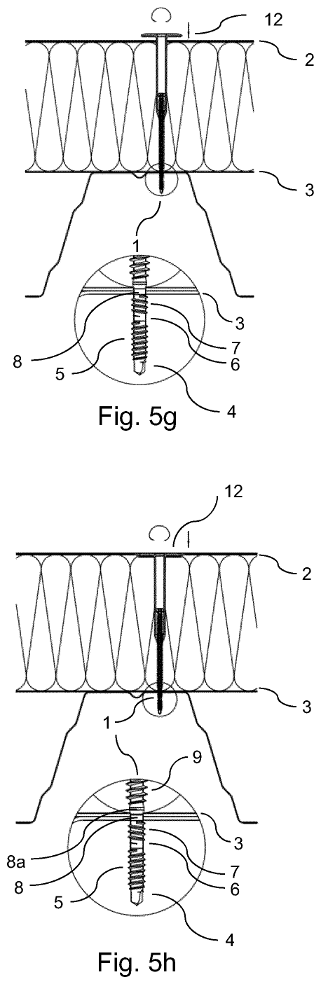

FIGS. 5a to 5d are schematic representations of the individual steps during the assembly of the system according to the invention from FIG. 4, also using the gradient insulation screw from FIG. 1B;

FIGS. 5e to 5h are schematic representations of the individual steps during the assembly of a system according to the invention consisting of the holding element from FIG. 3 and the gradient insulation screw from FIG. 1c;

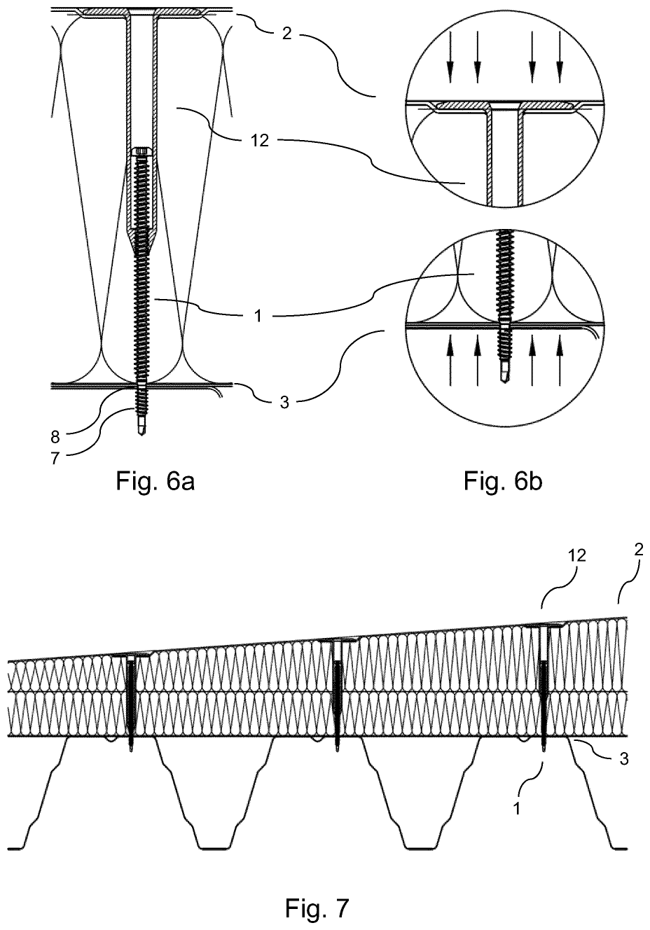

FIGS. 6a and 6b are schematic representations of the forces occurring during the screwing in of the gradient insulation screw for the system from FIG. 4; and

FIG. 7 is a schematic representation of several systems according to FIG. 4 consisting of gradient insulation screw and holding element in the screwed-in state for an inclined roofing membrane.

FIG. 1a shows a schematic representation of an embodiment of a gradient insulation screw 1 according to the invention. The gradient insulation screw 1 comprises a drilling tip 4, which is located at one end of the gradient insulation screw 1. In the exemplary embodiment shown in FIG. 1a, the drilling tip 4 is adapted to drill a hole into the substrate by a right-handed rotation.

An assembly thread 7, which is a left-handed thread in the exemplary embodiment shown here, follows the drilling tip 4. In the present example, the assembly thread 7 has substantially the same core diameter as the drilling tip 4.

A first thread-free region 8 follows the assembly thread 7 in the embodiment of the gradient insulation screw 1 according to the invention shown in FIG. 1a. In principle, the diameter of this first thread-free region 8 can also substantially correspond to the core diameter of the assembly thread 7 and the outer diameter of the drilling tip 4. In the embodiment shown here, a thickening 8a, i.e., a region having a larger diameter than the diameter of the first thread-free region 8, follows the first thread-free region 8 at the end facing away from the drilling tip. This thickening 8a can also be referred to as a collar. An adjustment thread 9 follows the first thread-free region 8 or the thickening 8a, respectively. The thickening 8a can be helpful during the assembly of the gradient insulation screw according to the invention, because it is prevented thereby that the adjustment thread 9 engages in the steel sheet 3.

According to the invention, the adjustment thread 9 has an outer diameter which is greater than the outer diameters of the drilling tip 4 and the assembly thread 7. A tool holder 10, with which a rotational movement can be transmitted to the screw, follows the adjustment thread 9.

In the exemplary embodiment shown in FIG. 1a, the gradient insulation screw 1 comprises, at the end opposite the drilling tip 4, a head, in which the tool holder 10 is arranged. The outer diameter of the head is greater than the core diameter of the adjustment thread 9.

The embodiment of the gradient insulation screw 1 according to the invention shown in FIG. 1a has been described starting from the drilling tip 4 up to the tool holder 10 with reference to the threads and regions of the screw following one another. However, it is clear to the person skilled in the art that these regions do not necessarily have to follow one another directly. The person skilled in the art also knows additional regions, which can be arranged between the thread-free regions and/or the threads without substantially influencing the function of the screw according to the invention. This is the case in the same way for the other embodiments shown and described.

FIG. 1b shows a schematic representation of a further embodiment of a gradient insulation screw 1 according to the invention. In this exemplary embodiment of the gradient insulation screw 1, a second thread-free region 4a is located between the drilling tip 4 and the assembly thread 7. In the present exemplary embodiment, the diameter of this second thread-free region 4a substantially corresponds to the core diameter of the drilling tip 4. The longitudinal extension of the second thread-free region 4a, i.e., the extension parallel to the longitudinal axis of the gradient insulation screw 1, corresponds at least to the thickness of a steel sheet. The longitudinal extension of the second thread-free region 4a can, however, also be significantly greater and correspond, for example, to a multiple of the thickness of a steel sheet.

In the exemplary embodiment of the gradient insulation screw 1 shown in FIG. 1c, a preassembly thread 5 follows the drilling tip 4. Although this is not shown in FIG. 1c, a second thread-free region 4a, as is shown in FIG. 1b, can be located between the drilling tip 4 and the preassembly thread 5. In addition, a third thread-free region 6 can, but does not have to, be arranged between the preassembly thread 5 and the assembly thread 7. The preassembly thread 5, like the drilling tip 4, has the first direction of rotation. In the exemplary embodiment shown here, this is a right-handed thread. In the present exemplary embodiment, the core diameter and the outer diameter of the preassembly thread 5 are each the same over the longitudinal extension of the preassembly thread 5. In connection with the invention, however, it is also possible, for example, for the core diameter and/or the outer diameter to increase over the length of the preassembly thread 5. For example, the core diameter and/or the outer diameter of the preassembly thread 5 can increase from the end which lies closer to the drilling tip 4 to the other end of the preassembly thread 5.

In the present exemplary embodiment, the core diameter and/or the outer diameter of the preassembly thread 5 and that of the core diameter and/or the outer diameter of the assembly thread 7 are of the same size. In connection with the present invention, however, the core diameter and/or the outer diameter of the preassembly thread 5 can also be smaller than the core diameter and/or the outer diameter of the assembly thread 7.

In the exemplary embodiment of the gradient insulation screw 1 according to the invention shown in FIG. 1c, a third thread-free region 6 is arranged between the preassembly thread 5 and the assembly thread 7. This third thread-free region 6 enables a simple change of the direction of rotation from the preassembly thread 5 with the first direction of rotation to the assembly thread 7 with the second direction of rotation.

FIG. 2a shows a schematic side view of a drilling tip 4 of a gradient insulation screw 1 according to the invention. In connection with the present invention, the drilling tip 4 comprises a first direction of rotation. The drilling tip 4 is therefore adapted to drill into a substrate when it is rotated in the first direction of rotation. For this purpose, the drilling tip 4 shown here comprises at least one cutting element.

A cutting element of the drilling tip is, in the embodiment shown in FIG. 2a, the main cutting edge 16a, which extends radially outwards from the tip of the drilling tip 4 at an angle to the axis of rotation of the gradient insulation screw 1. It could also be said that the main cutting edge 16a is arranged on the lateral surface of the body of the drilling tip 4. The drilling tip 4 may comprise one or more main cutting edges 16a, which form the first opening in the substrate in most applications. A further cutting element may be the secondary cutting edge 16b shown in FIG. 2a. The secondary cutting edge 16b is arranged on the lateral surface of the body of the drilling tip 4 in the embodiment shown in FIG. 2a. The secondary cutting edge 16b enlarges the drilling hole and removes any drill residues. The drilling tip 4 may comprise one or more secondary cutting edges 16b, which are preferably arranged on the outer side of the lateral surface in such a way that they protrude as a projection at least partially in relation to the cylindrical body. FIG. 2a also shows the second thread-free region 4a and the assembly thread 7, wherein in this embodiment the core diameter and the outer diameter of the assembly thread 7 are greater than the core diameter and the outer diameter of the drilling tip 4.

As can be seen from the synopsis of FIGS. 2a and 2b, the drilling tip 4 may comprise a chip groove 17, which in the present embodiment extends along the at least one main cutting edge 16a and/or the at least one secondary cutting edge 16b. The chip groove 17 extends substantially in the direction of the axis of rotation of the gradient insulation screw and is adapted to assist in the removal of the drilling chips.

FIG. 3 shows an embodiment of a holding element 12, as can be used together with the gradient insulation screws 1 described in FIGS. 1a to 1c in a system according to the invention.

The holding element 12 comprises at least two parts, a holding plate 13 and a hollow shaft 14. The holding plate 13 is adapted to rest on the roofing membrane, and thus to hold downwards the roofing membrane and the insulation arranged thereunder. The hollow shaft 14 is adapted such that the adjustment thread 9 can engage in the hollow shaft 14. In the embodiment shown in FIG. 3, the holding element 12 also comprises a connecting element 15, which connects the holding plate 13 and the hollow shaft 14 to one another. While the hollow shaft 14 comprises an inner diameter, which is adapted such that the adjustment thread 9 can engage therein, the connecting element 15—as shown in FIG. 3—may comprise a larger inner diameter. In the embodiment shown here, the end of the holding element 12, which lies opposite the holding plate 13, is adapted to taper in order to simplify the introduction of the fastening system consisting of gradient insulation screw 1 and holding element 12 into the roofing membrane 2 and into the insulating material.

FIG. 4 shows an example of a system 11 according to the invention consisting of the gradient insulation screw 1 shown in FIG. 1b and the holding element 12 shown in FIG. 3. In the embodiment of the system 11 consisting of gradient insulation screw 1 and holding element 12 shown here, the inner diameter of the connecting element 15 is greater than the outer diameter of the head of the screw 1, so that the head can be moved longitudinally in the connecting element 15, while the inner diameter of the hollow shaft 14 is smaller than the outer diameter of the head. This enables a screwing of the gradient insulation screw 1 into the holding element 12 until the head of the screw rests on a stop at the transition from the inner diameter of the connecting element 15 to the inner diameter of the hollow shaft 14. It is thereby prevented that the screw 1 can be rotated downwards, i.e., away from the assembling person, out of the holding element 12.

In the embodiment shown, the inner diameter of the hollow shaft 14 is smaller than the outer diameter of the adjustment thread 9 of the gradient insulation screw 1, but greater than the core diameter of the adjustment thread 9 of the gradient insulation screw 1.

FIGS. 5a to 5d show a schematic representation of the individual steps during the assembly of the system 11 according to the invention from FIG. 4, i.e., of the gradient insulation screw from FIG. 1b and the holding element from FIG. 3, for fastening a roofing membrane 2 on a steel sheet 3. FIG. 5a shows the resting of the drilling tip 4 of the gradient insulation screw 1 on the steel sheet 3 after the pushing in and the screwing of the system 11 into the roofing membrane 2 in the direction of the steel sheet 3 located underneath. The adjustment thread 9 is already located here in the hollow shaft 14 of the holding element 12, i.e., the screwing in of a counter thread into the hollow shaft 14 for the adjustment thread 9 has optionally already taken place beforehand. As already explained above, it is also possible that the counter thread is formed during the production of the holding element 12. Independently of this, the screwing in of the adjustment thread 9 into the hollow shaft 14 can take place before the assembly of the system or during the pushing in and the screwing in of the system 11 into the roofing membrane 2.

In FIG. 5a, the holding plate 13 is located in the vicinity of the roofing membrane 2 after the initial pushing in, but not necessarily on the roofing membrane 2. The gradient insulation screw 1 is now rotated further in the first direction of rotation, in the example of FIG. 5a in right-handed direction. However, this does not necessarily lead to a corresponding rotation of the holding element 12, since the holding element 12 is held by the insulating material of the roofing membrane 2. For this purpose, the holding force caused by friction can be sufficient. Alternatively, the holding element 12 can comprise projections, which prevent any co-rotation of the holding element 12. With continued right-handed rotation, under slight pressure from above, the drilling tip 4 of the gradient insulation screw 1 penetrates through the steel sheet 3, until the steel sheet 3 is located in the second thread-free region 4a of the gradient insulation screw 1. At the same time, the adjustment thread 9 rotates into the hollow shaft 14 of the holding element 12.

When the drilling tip 4 and optionally the second thread-free region 4a penetrate the steel sheet 3, this causes an axial movement of the gradient insulation screw 1 in the direction of the substrate. The rotation of the adjustment thread 9 of the gradient insulation screw 1 in the hollow shaft 14 of the holding element 12 in the first direction of rotation has the effect of that the holding element 12 moves axially and relative to the gradient insulation screw 1 upwards, i.e., away from the substrate. When, due to the screwing in, the holding element 12 moves upwards more quickly relative to the gradient insulation screw 1 than the gradient insulation screw 1 moves in the direction of the substrate due to the lowering of the drilling tip 4 and the second thread-free region 4a through the steel sheet 3, the distance between the holding plate 13 of the holding element 12 and the roofing membrane 2 increases. If the drilling tip 4 and optionally the second thread-free region 4a move faster through the steel sheet 3 than the holding element 12 moves away from the gradient insulation screw 1, the distance between the holding plate 13 of the holding element 12 and the roofing membrane 2 decreases. When both movements take place almost equally quickly, the distance of the holding plate 13 from the roofing membrane 2 does not change.

In the embodiment shown in FIG. 5a, there is a substantial difference between the movement of the drilling tip 4 through the steel sheet 3 and the relative movement between the gradient insulation screw 1 and the holding element 12. The relative movement between the gradient insulation screw 1 and the holding element 12 is a substantially continuous movement that depends on the rotational speed of the gradient insulation screw 1 and the pitch of the adjustment thread 9. In the embodiment shown in FIG. 5a, the speed at which the drilling tip 4 moves through the steel sheet 3 is discontinuous. First, the drilling tip 4 moves very slowly in the direction of the substrate, while the drilling tip 4 slowly starts drilling the steel sheet 3. As soon as a sufficiently large hole exists in the steel sheet 3, the drilling tip 4 and optionally a thread-free region following thereon moves quickly through the steel sheet 3 until the movement is stopped, for example, by a thread. However, this movement does not necessarily have to be the case in connection with the present invention. As already explained above, the drilling tip can also comprise a thread. This thread can be adapted in such a way that the drilling tip moves at least temporarily continuously through the steel sheet. If the gradient insulation screw 1 comprises, for example, a preassembly thread 5, as is shown in FIG. 1c, the gradient insulation screw 1 moves continuously in the direction of the substrate after the drilling tip 4 has been pushed quickly through the steel sheet 3. The speed of this movement then also depends again on the rotational speed of the gradient insulation screw 1 and the pitch of the preassembly thread 5.

FIG. 5b now shows the situation after the drilling tip 4 has penetrated the steel sheet 3. The assembly thread 7 with the second direction of rotation follows the second thread-free region 4a. In the exemplary embodiment shown here, this is a left-handed thread. This assembly thread 7 with the second direction of rotation prevents the gradient insulation screw 1 from moving further in the direction of the substrate when it is rotated further in the first direction of rotation. Since—as described above—the holding element 12 is held by the roofing membrane 2, the further rotation of the gradient insulation screw 1 has the effect of that the adjustment thread 9 moves in the counter thread in the hollow shaft 14 of the holding element 12. This leads to that, during a rotation of the gradient insulation screw 1 in the first direction of rotation, the hollow shaft 14 of the holding element 12 moves on the adjustment thread 9 in direction of the tool holder 10. This also has the effect of that the holding plate 13 of the holding element 12 moves again away from the roofing membrane 2. When the assembling person sees this, he knows that the drilling tip 4 has penetrated the steel sheet 3 and that he can therefore now change the direction of rotation from the first to the second direction of rotation, i.e., in the example shown here from right-handed to left-handed run.

By the rotation of the gradient insulation screw 1 in the second direction of rotation, here in the left-handed direction and optionally by slight pressure from above on the gradient insulation screw 1, the assembly thread 7 of the gradient insulation screw 1 now engages in the steel sheet 3 and the assembly thread 7 is screwed into the steel sheet 3 until the steel sheet 3 is located in the first thread-free region 8, as shown in FIG. 5c.

In this case, the holding plate 13 of the holding element 12 is lowered again in the direction of the roofing membrane 2, since firstly the gradient insulation screw 1 passes further downward through the steel sheet 3 and since secondly, due to the left-handed rotation, the holding element 12 moves in the direction of the drilling tip 4 of the gradient insulation screw 1. This is indicated in FIG. 5c by the arrow next to the holding plate of the holding element 12.

A possible thickening 8a, which follows the end of the thread-free region 8 facing the adjustment thread 9, can prevent the steel sheet 3 from not being pressed out of the first thread-free region 8 in the direction of the adjustment thread 9 despite pressure from above on the gradient insulation screw 1, e.g., by a battery-operated screwdriver.

With continued rotation of the gradient insulation screw 1 in the second direction of rotation, as shown in FIG. 5d, the steel sheet 3 remains in the first thread-free region 8 and the holding plate of the holding element 12 is pulled further onto the roofing membrane 2. This further pulling of the holding plate 13 of the holding element 12 against the roofing membrane 2 is represented in FIG. 5d by the vertical arrow. Thereby, a re-entry of the assembly thread 7 of the gradient insulation screw 1 into the steel sheet 3 is avoided, since an opposite direction of rotation of the gradient insulation screw 1, namely a rotation in the first direction of rotation (here: right-handed rotation), would be necessary for this purpose. The continued rotation of the gradient insulation screw 1 in the second direction of rotation is stopped when the holding plate 13 of the holding element 12 is pulled with the desired force onto the roofing membrane 2.

When using an additional preassembly thread on the gradient insulation screw, the steps of FIGS. 5a to 5d are slightly modified. This is described in the following. FIGS. 5e to 5h show a schematic representation of the individual steps during the assembly of a system 11 according to the invention consisting of gradient insulation screw 1 from FIG. 1c and a holding element from FIG. 3 for fastening a roofing membrane 2 on a steel sheet 3. FIG. 5e shows the resting of the drilling tip 4 of the gradient insulation screw 1 on the steel sheet 3 after pushing in and screwing in of the system 11 into the roofing membrane 2 in the direction of the steel sheet 3 located underneath. The gradient insulation screw 1 is now rotated further in right-handed direction. The holding plate 13 is still located at a certain distance from the roofing membrane 2. With continued right-handed rotation, the drilling tip 4 of the gradient insulation screw 1 penetrates through the steel sheet 3, and the preassembly thread 5 of the gradient insulation screw 1 is screwed through the steel sheet 3, until the steel sheet 3 is located in the third thread-free region 6 of the gradient insulation screw 1. This situation is represented in FIG. 5f. Thereby, the distance between the holding element 12 and the roofing membrane 2 has initially not yet changed, since, due to the right-handed rotation, not only the preassembly thread 5 of the gradient insulation screw 1 moves into the steel sheet 3, but also the adjustment thread 9 rotates relatively to the hollow shaft 14 of the holding element 12 and thus the hollow shaft 14 of the holding element 12 moves on the adjustment thread 9 in direction of the tool holder 10. With continued right-handed rotation, the gradient insulation screw 1 now rotates freely in the thread-free region 6 in the steel sheet 3 and does not enter further into the steel sheet 3. Thereby, the holding plate 13 lifts off further from the roofing membrane 2, as represented by the arrow in FIG. 5f, since, due to the continued right-handed rotation, the adjustment thread 9 of the gradient insulation screw 1 rotates further relatively to the hollow shaft 14. By means of the lifting off of the holding element 12, it is indicated to the assembling person that the direction of rotation should be changed from right-handed to left-handed run.

By subsequent left-handed rotation of the gradient insulation screw 1 and optionally by slight pressure from above on the gradient insulation screw 1, the assembly thread 7 of the gradient insulation screw 1 now engages in the steel sheet 3 and is screwed in until the steel sheet 3 is located in the first thread-free region 8, as shown in FIG. 5g. Thereby, the holding plate 13 of the holding element 12 is lowered again in the direction of the roofing membrane 2, since firstly the gradient insulation screw 1 passes further downward through the steel sheet 3 and since secondly, due to the left-handed rotation, the holding element 12 moves in the direction of the drilling tip 4 of the gradient insulation screw 1. This is indicated in FIG. 5g by the arrow next to the holding plate.

As described above, a possible thickening 8a following the first thread-free region 8 can prevent the steel sheet 3 from not being pressed out of the first thread-free region 8 in the direction of the adjustment thread 9 despite pressure from above on the gradient insulation screw 1.

With continued left-handed rotation of the gradient insulation screw 1, as shown in FIG. 5h, the steel sheet 3 remains in the first thread-free region 8 and the holding plate 13 of the holding element 12 is pulled further onto the roofing membrane 2. This further pulling of the holding plate 13 against the roofing membrane 2 is represented in FIG. 5h by the vertical arrow. As above, a re-entry of the assembly thread 7 of the gradient insulation screw 1 into the steel sheet 3 is thereby avoided, since an opposite direction of rotation of the gradient insulation screw 1, namely a right-handed rotation, would be necessary for this purpose. Here too, the continued left-handed rotation of the gradient insulation screw 1 is stopped when the holding plate 13 of the holding element 12 is pulled with the desired force onto the roofing membrane 2.

FIGS. 6a and 6b show by way of example a schematic representation of the forces occurring during the screwing in of the gradient insulation screw 1. When the first thread-free region 8 of the gradient insulation screw 1 is located in the steel sheet 3, the holding plate 13 of the holding element 12 is pulled in the direction of the roofing membrane 2 by continued left-handed rotation. As a result, two forces act on the insulating material, at the steel sheet 3 and at the holding plate 13. These forces are illustrated in FIG. 6b with the aid of arrows.

In FIG. 7, three systems 11 consisting of gradient insulation screw 1 and holding element 12 are represented at three locations of different roof thickness for an inclined roofing membrane 2 after the assembly. Hereby, it can be seen that the interplay of the adjustment thread of the gradient insulation screw 1 and the hollow shaft 14 of the holding element 12 enables various vertical total lengths of the system 11 consisting of gradient insulation screw 1 and holding element 12, without the gradient insulation screws 1 protruding differently far below the steel sheet 3.

1. A gradient insulation screw (1) for adjustable fastening of a roofing membrane (2) on a substrate, in particular a steel sheet (3), the gradient insulation screw (1) comprising:
a drilling tip (4) with a first direction of rotation;
following the drilling tip (4), an assembly thread (7) with a second direction of rotation, which differs from the first direction of rotation;
following the assembly thread (7), a first thread-free region (8);
following the first thread-free region (8), an adjustment thread (9) with the first direction of rotation, the outer diameter of which is greater than the outer diameters of the assembly thread (7) and the drilling tip (4); and
following the adjustment thread (9), a tool holder (10).

2. The gradient insulation screw (1) according to claim 1, wherein a second thread-free region (4a) is arranged between the drilling tip (4) and the assembly thread (7).

3. The gradient insulation screw (1) according to claim 1, wherein a preassembly thread (5) with the first direction of rotation is arranged between the drilling tip (4) and the assembly thread (7).

4. The gradient insulation screw (1) according to claim 3, wherein a third thread-free region (6) is arranged between the preassembly thread (5) and the assembly thread (7).

5. The gradient insulation screw (1) according to claim 3, wherein the preassembly thread (5) and the assembly thread (7) have substantially the same outer diameter.

6. The gradient insulation screw (1) according to claim 3, wherein the preassembly thread (5) and the assembly thread (7) have substantially the same core diameter.

7. The gradient insulation screw (1) according to claim 4, wherein the third thread-free region (6) comprises a length in the longitudinal direction of the gradient insulation screw (1) which is greater than the thickness of the substrate.

8. The gradient insulation screw (1) according to claim 1, wherein the first thread-free region (8) comprises a length in the longitudinal direction of the gradient insulation screw (1) which is greater than the thickness of the substrate.

9. The gradient insulation screw (1) according to claim 1, wherein the first thread-free region (8) is followed by a thickening (8a), wherein the thickening (8a) has a diameter which is greater than the diameter of the first thread-free region (8).

10. A system (11) for adjustable fastening of a roofing membrane (2) on a substrate, in particular a steel sheet (3), consisting of a gradient insulation screw (1) according to claim 1 and a holding element (12), the holding element (12) comprising:
a holding plate (13); and
a hollow shaft (14), which follows the holding plate (13) and which is adapted such that the adjustment thread (9) of the gradient insulation screw (1) can engage in the hollow shaft (14).

11. The system (11) according to claim 10, wherein the inner diameter of the hollow shaft (14) of the holding element (12) is smaller than the outer diameter of the adjustment thread (9), but greater than the core diameter of the adjustment thread (9) of the gradient insulation screw (1).

12. The system (11) according to claim 10, wherein the inner diameter of the hollow shaft (14) of the holding element (12) is greater than the outer diameter of the assembly thread (7) of the gradient insulation screw (1).

13. The system (11) according to claim 10, wherein the gradient insulation screw (1) is made of a material which is harder than the material of the holding element (12).

14. The system (11) according to claim 13, wherein the gradient insulation screw (1) is made of metal and the holding element (12) is made of plastic.

15. A method for adjustable fastening of a roofing membrane (2) on a substrate, in particular a steel sheet (3) using a system (11) according to claim 10, the method comprising:
pushing the drilling tip (4) of the gradient insulation screw (1) of the system (11) into the roofing membrane (2) in the direction of the substrate located underneath;
screwing the drilling tip (4) of the gradient insulation screw (1) into the substrate in a first direction of rotation;
screwing the assembly thread (7) of the gradient insulation screw (1) into the substrate in a second direction of rotation, which differs from the first direction of rotation, until the first thread-free region (8) of the gradient insulation screw (1) is located in the substrate; and
rotating the gradient insulation screw (1) furthermore in the second direction of rotation until the holding plate (13) of the holding element (12) of the system (11) rests on the roofing membrane (2).
